(19) United States
(12) Patent Application Publication
(10) Pub. No.: US 2008/0097663 A1
(43) Pub. Date: Apr. 24, 2008

(54) Client management apparatus

(75) Inventor: Yasuaki Morimoto, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 12/001,584

(22) Filed: Dec. 12, 2007

Related U.S. Application Data
(63) Continuation of application No. PCT/JP2005/011474, filed on Jun. 22, 2005.

(51) Int. Cl. G01M 17/00

(52) U.S. Cl. 701/29

(57) ABSTRACT

A client managing database for storing information on the diagnosis request record, the diagnosis result needing a dealer check for repair or adjustment of the mobile body, the inspection result, the inspecting dealer, and the inspection report for each client receiving a mobile object diagnosis service. The dealer having implemented an inspection on the mobile object registers the information on the inspection report in the client managing database, and the client having received the inspection can refer to the information on the inspection report.

### CROSS REFERENCE TO RELATED APPLICATION

This application is a continuation application of International PCT Application No. PCT/JP2005/011474 which was filed on Jun. 22, 2005.

### BACKGROUND OF THE INVENTION

1. Field of the Invention

The present invention relates to a client management apparatus for managing information of a plurality of clients who receive diagnosis services for mobile objects such as automobiles or the like.

2. Description of the Related Art

As an example of a conventional mobile information service system for making diagnosis on statuses of moving automobiles, Patent Document 1 below, for example, discloses a configuration as described below.

In this system, users' mobile information devices that are mounted on the automobiles receive information such as the latest states of roads, weathers, and destinations that is transmitted from the information provision company. Also, positional information of the automobiles that are acquired by the navigation systems and sensor data acquired through various sensors mounted on the automobiles are analyzed by using self-diagnosis functions included in the automobiles, and the analyzed information is transmitted from the mobile information devices to the information provision company and the automobile company at a real time. The automobile company continuously monitors the operation statuses of the automobiles on the basis of the received analyzed information, and provides appropriate information in accordance with the corresponding statuses to the mobile information devices that the users carry.

The main characteristic of this conventional technique is the configuration in which data acquired through various sensors mounted on automobiles are analyzed by the self-diagnosis functions prior to transmission, and the analysis results are always transmitted to information provision company and automobile company, such that users' mobile information devices can always receive appropriate information.

Also, as a conventional vehicle information management system that follows up maintenance/inspection of vehicle by exchanging data about users' vehicle between the users' terminals and the vehicle information management company, Patent Document 2, for example, discloses a technique as described below.

In this system, vehicle data is extracted from electronic control units mounted on vehicle in order to be stored on memory cards, and is transferred to the hard disks in the users' terminals. The users' terminals access the users-only-web site prepared by the vehicle information management company, and the diagnosis information is displayed on the Web page.

Also, the vehicle data is transferred from the electronic control units to the mobile phones, and the diagnosis information is displayed on the Web pages displayed in the mobile phones instead of the users' terminals. Thereby, the diagnosis information is provided in a real time.

However, the above conventional automobile diagnosis system has a problem below.

When it is determined on the basis of a diagnosis that an automobile needs repair or an adjustment, the user requests the inspection of his or her automobile from the car dealer, and the car dealer reports the inspection result to the automobile manufacturer as necessary. In this configuration, if the reports from the car dealers involve deceitful or incorrect information, the automobile manufacturer cannot accurately obtain operation statuses of the automobiles that the manufacturer has sold.

Patent Document 1:

Japanese Patent Application Publication No. 2002-230658

Patent Document 2:

Japanese Patent Application Publication No. 2003-011747

### SUMMARY OF THE INVENTION

It is an object of the present invention to accurately understand the operation statuses of mobile objects that have been sold, by managing the results of inspection requests for repair or adjustments of the mobile objects such as automobiles or the like being made to car dealers by the users who have received the diagnosis service for the mobile objects.

The client management apparatus according to the present invention includes a client management database, a reception unit, an update control unit, a reference control unit, and a transmission unit in order to manage information of a plurality of clients who receive diagnosis services for mobile objects.

The client management database stores, for each client, information of a contract number for the diagnosis service, a diagnosis-request record that expresses the status of requesting the diagnosis service, an inspection-needing diagnosis record that expresses the diagnosis result that requires an inspection by a car dealer for the repair or adjustment of the mobile object, an inspection record that expresses an implementation status of the inspection, an inspecting dealer that expresses the dealer that implemented the inspection, and an inspection report.

The reception unit receives a reference request or a data-update request from the clients' terminal or the dealers' terminal. When receiving the data-update request from a terminal of a dealer that implemented an inspection of a mobile object, the update control unit registers in the client management database information of the inspection record, the inspecting dealer, and the inspection report as the information of the client whose mobile object was subjected to the inspection. When receiving the reference request from a terminal of a client whose mobile object was subjected to an inspection, the reference control unit extracts information of the inspection report registered in the client management database, and the transmission unit transmits the extracted information of the inspection report to the terminal of the client whose mobile object was subjected to the inspection.

The client management database, the update control unit, and the reference control unit respectively correspond to a client management database 211, an update control unit 903, and a reference control unit 902 shown in, for example, FIG. 9 being explained later. The reception unit and the transmission unit correspond to the access control management unit 901 shown in, for example, FIG. 9.

### BRIEF DESCRIPTION OF THE DRAWINGS

FIG. 1 shows an outline of a diagnosis service;

FIG. 2 shows the relationship among an automobile manufacturer, a user, and a car dealer in the diagnosis service;

FIG. 3 shows a configuration of a system for a first diagnosis provision service;

FIG. 4 shows information in a client management database;

FIG. 5 shows the relationship among the automobile manufacturer, the user, the car dealer, and a supporting company in the diagnosis service;

FIG. 6 shows a configuration of a system for a second diagnosis provision service;

FIG. 7 shows the relationship among the automobile manufacturer, the user, the car dealer, the supporting company, and a casualty insurance company in the diagnosis service;

FIG. 8 shows a configuration of a system for a third diagnosis provision service;

FIG. 9 shows a configuration of client management control unit and the client management database;

FIG. 10 shows a data configuration of an ID;

FIG. 11 shows a data configuration of client-by-client total management data file;

FIG. 12 shows a data configuration of a dealer-based data file;

FIG. 13 shows a data configuration of a casualty insurance company-based data file;

FIG. 14 shows a data configuration of a client-based data file;

FIG. 15 is a flowchart for an accessing process;

FIG. 16 shows a configuration of an information processing device; and

FIG. 17 shows a method of providing a program and data.

### DESCRIPTION OF THE PREFERRED EMBODIMENTS

Hereinafter, preferred embodiments for carrying out the present invention will be explained in detail by referring to the drawings.

In the present embodiment, a mobile phone is used as an example of a mobile information device. However, an information processing device such as a PDA (Personal Digital Assistant) or the like can be used instead of a mobile phone. Also, an automobile is used as an example of a mobile object that is a diagnosis target. However, not only automobiles but also heavy equipment (bulldozers, crane vehicles, and the like), trains, watercraft, aircraft or the like can be used. The use of mobile objects includes both the private use and the business use. An automobile manufacturer that manufactures automobiles is used as an example of a diagnosis service provider, and a car dealer that is included in a group of the automobile company is used as an example of a seller of mobile objects.

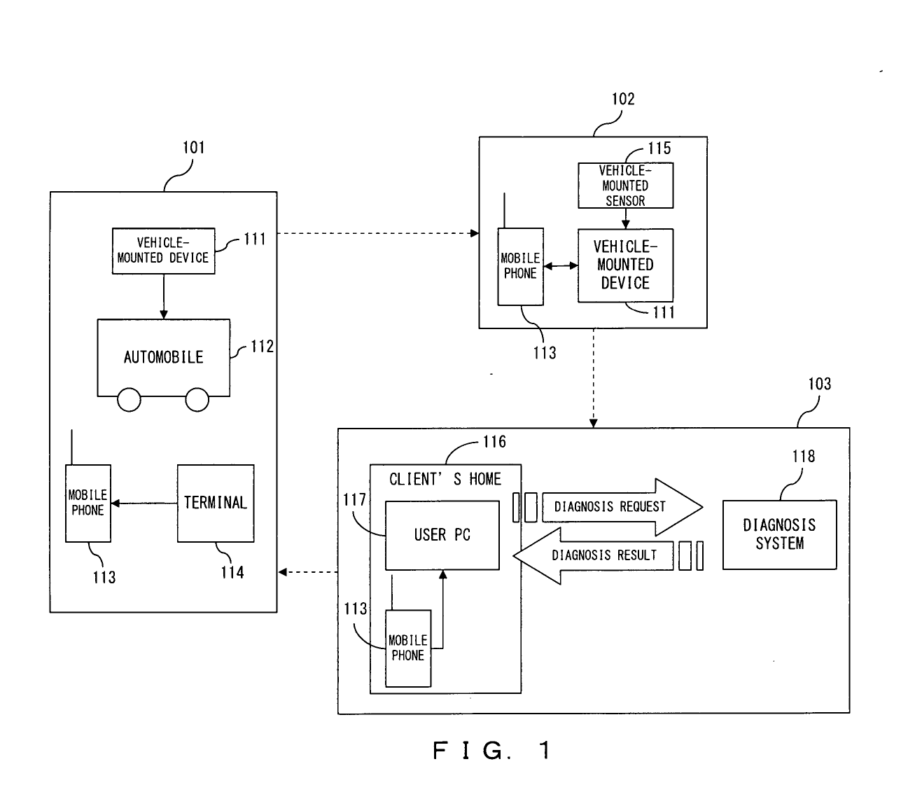

FIG. 1 shows an outline of a diagnosis service on which the present invention is based. In a shop 101 of a car dealer, a contract stipulating that a user as a client buys an automobile 112 and a contract stipulating that the user can receive services accompanying the purchase of the automobile are made. These services include a service of making a diagnosis on the operation statuses of the automobile 112 in such a manner that this service is associated with data acquired from a mobile phone 113 and a vehicle-mounted device 111 (including a navigation system).

Then, an application program is installed (downloaded), that enables the extraction, from a service provision system introduction terminal 114 to the mobile phone 113 that the user carries, of data needed for performing the services. This service provision system introduction terminal 114 is provided in the shop 101.

In an automobile moving scene 102, a user mounts the mobile phone 113 on a position (for example, a mobile phone connection box or a holder provided on a dashboard). The vehicle-mounted device 111 transmits, to the mobile phone 113, the raw data obtained from a vehicle-mounted sensor 115 that is mounted on the automobile 112 and information such as the latitude, the longitude, the name of place, the route number and the like that is acquired by the vehicle-mounted device 111 itself. When the information is transmitted, the transmitted information is stored in a storage medium in the mobile phone 113 after being converted into a prescribed format.

In a service-utilization-scene 103, the user returns to his/her home taking the mobile phone 113 removed from the automobile 112, and the user opens a Web page of an automobile company via the Internet by using a user PC (Personal Computer) 117 in order to call a diagnosis system 118. Then, the information that has been stored in the mobile phone 113 is transmitted to the diagnosis system 118 via the PC 117, and a request is made to the diagnosis system 118 for the diagnosis service. The request for the diagnosis service can be made not only at a home 116, but also in any place including an office or the like in which there is a PC.

The user makes a search for determining the car dealer that is the most suitable for making a request for an inspection on the basis of the diagnosis result received from the diagnosis system 118, and transmits the diagnosis result to the determined car dealer via the Internet. The car dealer transmits to the user the scheduled date for the inspection of the automobile 112 and the like on the basis of the diagnosis result.

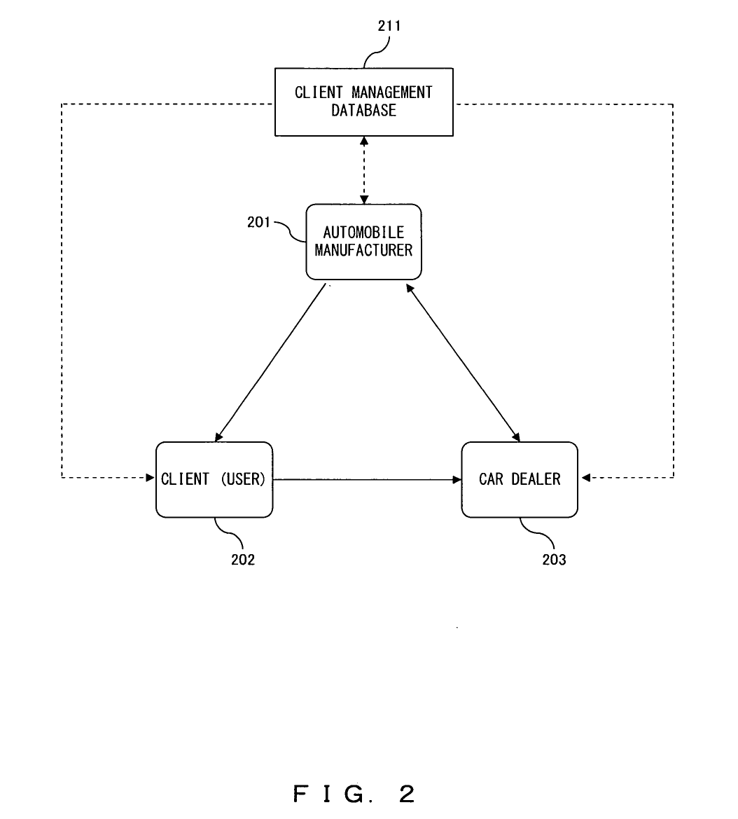

FIG. 2 shows the relationship among the automobile manufacturer, the user, and the car dealer in the diagnosis service. An automobile manufacturer 201 makes a contract with a user 202 to provide a service to a user 202 in a shop of a car dealer 203. This contract includes the provisions of diagnosises. The user 202 pays the fee (the contract fee and the annual fee) to the car dealer 203 with the credit card or the like.

The automobile manufacturer 201 provides shops of car dealers 203 with equipment and software necessary for using the system, and pays to the car dealers 203 a part of the fees received from the users 202 as the contribution fee in accordance with the contribution by the car dealers 203 to the automobile manufacturer 201. As a criterion for determining the contribution fee, financial merit or non-financial merit for the automobile manufacturer 201 is adopted.

Examples of the financial merit for the automobile manufacturer 201 are income based on the contracts for the service, the improvement in the development efficiency and the design costs, and the like due to the construction of databases and due to the utilization of the diagnosis data. The database consists of the diagnosis data collected from the users. These factors (income, improvement, and etc.) can be converted into numbers to be used in the account settlement or the like of the automobile manufacturer 201, thus can be reliable criterion. Also, as an example of the non-financial merit, it is possible to understand the degrees of customers' satisfaction by performing inquiry survey, and to improve the degrees of customers' satisfaction by using the result of the inquiry survey.

An example of the financial merit for the car dealer 203 is to receive the distribution of the fees paid by the users 202 and the increase in the income based on repairs and exchange of parts due to the increased number of users requesting repairs and parts exchanging. Also, as the non-financial merit, the chance of directly contacting users 202 increases, leading to the increase in the confidence of the users 202.

Examples of the merit for the users 202 are the financial merit of being able to avoid repairs that are unnecessarily extensive and non-financial merit of being able to drive their vehicles always without anxiety and to recognize the importance of precaution against disorder.

Next, an incentive system employed for providing the service is explained in more detail.

A prescribed ratio (50 percent for example) of the contract fees and the annual fees received from the users 202 is distributed to each car dealer 203 from the automobile manufacturer 201. The automobile manufacturer 201 has, in the diagnosis system, the client management database 211 used for knowing the changes in the number of the contacts in each car dealer 203, and can give higher percentage of the distribution to car dealers 203 that are excellent in the evaluation of the number of the contracts by automatically counting the number of the contracts in each car dealer 203. Also, the percentage of distribution for the car dealers 203 that are highly ranked in the evaluation may be announced to all the car dealers via the diagnosis system.

The diagnosis system sets, as the criteria for the evaluation, the evaluation points respectively for the percentage of increase in the number of contracts in comparison with the previous year, the percentage of the contract cancellation, the percentage at which the users 202 visit the car dealers with respect to the number of the diagnosis requests, and the like. Thereby, the diagnosis system periodically and comprehensively evaluates the degrees at which the services are efficiently provided to the clients. The above described percentage at which the users 202 visit each car dealer with respect to the number of diagnosis requests is the ratio between the number of the users' visits to each car dealer and the number of diagnosis requests.

When there is a diagnosis result that indicates the necessity of a repair or adjustment (inspection-needing diagnosis) as a result of a diagnosis request from a user 202, the car dealer 203 creates, on the diagnosis system, a maintenance completion report (inspection report) that describes the result of the repair or adjustment on the automobile of the user 202, and describes the diagnosis request number of the user 202 on the maintenance completion report in order to transmit the maintenance completion report to the automobile manufacturer 201.

The diagnosis system in the automobile manufacturer 201 that has received the maintenance completion report automatically transmits the maintenance completion report to the user 202 in a form of a Web mail or an e-mail with the mail address specified by the user 202. Thereby, the user 202 can refer to the maintenance completion report any time, leading to the effect of deterring car dealers from making deceitful reports or incorrect reports.

The diagnosis system has the client management database 211 for storing diagnosis-request records of the users 202, reports on diagnosis results and the prescription based on the diagnosis results, maintenance completion reports issued by the car dealers 203, and the like in order to electronically hold information of the users 202, thereby series of statuses regarding the diagnosis request by the users 202 are managed in an integrated manner. Thereby, it is possible to give back to the users 202 the points that are service provision.

The diagnosis system sets, as the criteria for the point-back, evaluation points respectively for diagnosis-request records, the ratio of the inspection implementation to the inspection-needing diagnosis records that indicate the necessity of repairs or adjustment, and evaluates the clients periodically. On the Web page provided by the diagnosis system, the user 202 can confirm the point that is periodically updated, by using the user's ID and password. This point may be associated with the discount rate of the fee that has to be paid for the repair or adjustment, and also may be used as the discount rate for the price of an automobile such that when the user wants a new automobile, he or she again buys an automobile of the manufacturer that uses the diagnosis system.

The pieces of information that the automobile manufacturer 201, the user 202, and the car dealer 203 can obtain respectively from the client management database 211 are as follows.

(1) Automobile manufacturer

Utilization status of diagnosis system by a user

Contract status of a car dealer

Status of repair or the like based on diagnosis result

(2) User

Diagnosis service utilization status

Point obtained

(3) Car dealer

Evaluation made by the automobile manufacturer

Distribution of utilization fees from the automobile manufacturer

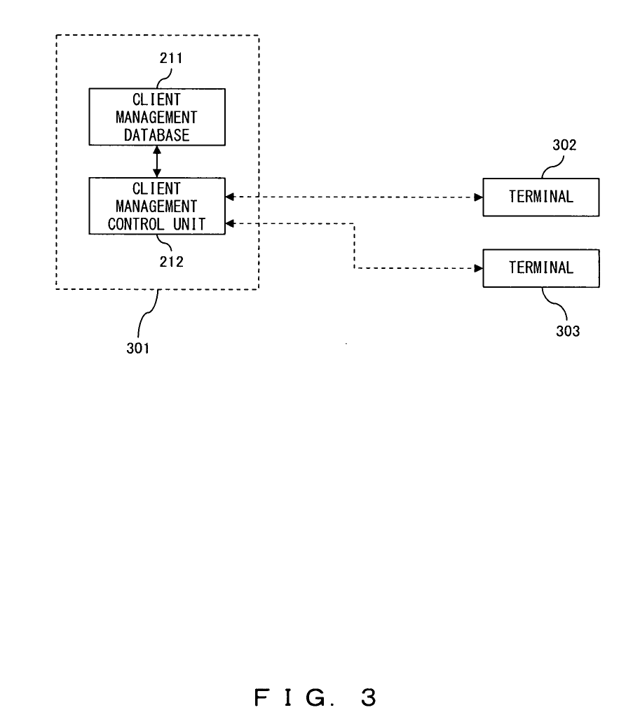

FIG. 3 shows an example of a configuration of a system for the diagnosis service shown in FIG. 2. A server 301 in the automobile manufacturer 201 has the client management database 211 and a client management control unit 212. The client management control unit 212 constitutes a part of the diagnosis system, and have communications with terminals 302 of the users 202 and terminals 303 of the car dealers 203 via the Internet.

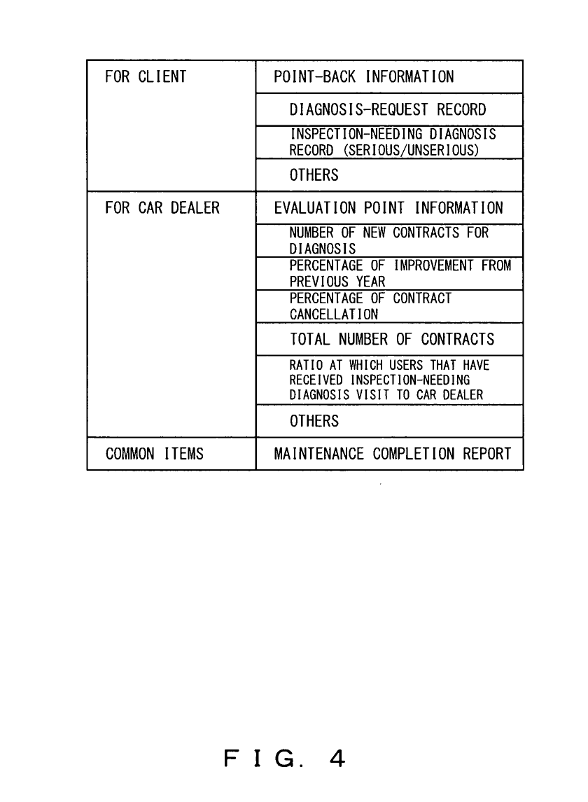

As shown in FIG. 4, the client management database 211 stores, for example, the information as below.

(1) Information for clients

Point-back information

Diagnosis-request records

Number of inspection-needing diagnosis records

(serious/unserious)

Others

(2) Information for car dealers

Evaluation point information

Number of new contracts for diagnosis

Percentage of increase in the number of contracts in comparison with the previous year

Percentage of contract cancellation

Ratio at which the users that have received the inspection-needing diagnosis visit to car dealers

Others

(3) Common items

Maintenance completion report

The car dealer 203 transmits from the terminal 303 to the client management control unit 212 information such as new contract registration, maintenance completion reports, and the like via the Internet. The client management control unit 212 periodically performs various evaluations by referring to the client management database 211, and updates the client management database 211. The above various evaluations include counting the number of contracts that the users 202 cancelled. The car dealers 203 can refer to the latest evaluation results through the terminals 303.

The user 202 transmits the diagnosis request from the terminal 302 to the client management control unit 212 via the Internet. The client management control unit 212 periodically performs the various evaluations by referring to the client management database 211, and updates the client management database 211. The above various evaluations include evaluating the diagnosis requests records, the visit records based on the maintenance completion reports, and the like. The user 202 can refer to the updated point-back information from the terminal 302.

By providing an incentive system for the car dealers 203 and the users 202 as described above, the car dealers 203 can confirm the evaluation points based on the contract statuses and the like, which brings to them motivations for acquiring contracts. Also, by providing the merit of the point-back to the users 202, it is possible to encourage the users 202 to use the diagnosis system.

As a result of this, the automobile manufacturer 201 can acquire many clients who make contracts newly, and it is possible to use the diagnosis data obtained from these clients for developing new automobiles and for reducing risks for example by early finding the models to be recalled. Also, it is possible to construct accurate databases that are based on the latest information, which brings the expectation of the effect of the further reduced cost for the automobile manufacturer 201.

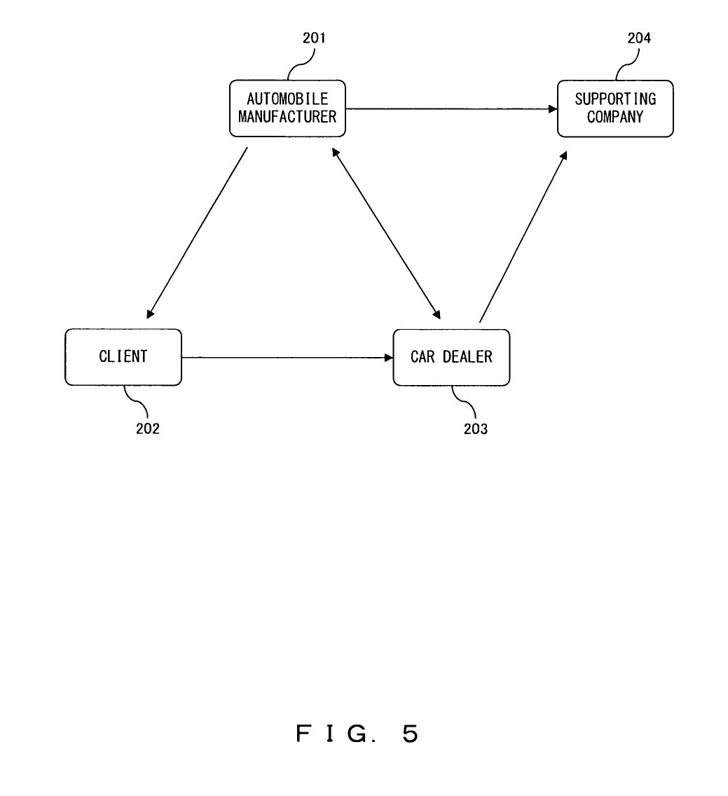

FIG. 5 shows an example in which a supporting company for supporting the provision of the diagnosis service is added for further developing the diagnosis service shown in FIG. 2. A supporting company 204 develops the diagnosis system to be used by the automobile manufacturer 201, and receives a part of distribution of the utilization fees in association with the number of diagnosis service contracts, the diagnosis records, and the percentage at which the users 202 visit the car dealers.

Also, the supporting company 204 installs, maintains, manages, and updates the system for the car dealers 203 as necessary. Also, the supporting company 204 serves as an interface between the users 202 and the car dealers 203.

As an example of an operation as the interface, the supporting company 204 manages the Web pages of the automobile manufacturer 201, and updates into the latest version the information such as contents of the services provided by the respective car dealers 203 so that the users 203 can retrieve the most suitable car dealer 203 in views of the time and place.

Also, the supporting company 204 prepares Web pages that are linked to the Web pages of the automobile manufacturer 201, receives requests for introducing car dealers 203 from the users 202, and notifies the users 202 of the car dealer 203 that meets the conditions. Also, the supporting company 204 delivers requests, complaints, and the like on the diagnosis services between the users 202 and the car dealers 203.

By using the above interface, the automobile manufacturer 201 can reduce the management burden of system without risking the confidential information. The supporting company 204 receives the contribution fee from the automobile manufacturer 201 in accordance with the criteria such as increase in the total amount of money contracted/the number of the contracts, the improvement in the efficiency in the development and improvement in the automobile manufacturer 201, increase in the profit to the car dealers 203, and the like.

The supporting company 204 can receive, as the financial merit, the contribution fee in accordance with the total amount of money contracted, the number of the car dealers under contracts, and the introduction fee by introducing the users 202 to the car dealers 203 on the Web pages. As the non-financial merit, it is possible to estimate the degrees of satisfaction of the automobile manufacturer 201, the users 202, and the car dealers 203 in order to attain higher efficiency in development, maintenance, management, and update of the system.

Next, a profit structure in the supporting company 204 shown in FIG. 5 is explained in more detail.

The profit that the supporting company 204 gains mainly includes the merit fee from the automobile manufacturer 201, and the visit-introduction fee that is from the car dealers 300 and is based on repairs and adjustment. For example, an initial merit fee is set to be ten percent of the total contract incomes. The merit fee varies depending upon the increase in the number of the total number of the entire diagnosis service and the percentage of the contract cancellation in the automobile manufacturer 201, the vehicle development cost, the risk cost, the field failure rate reduction effect in the entire automobile manufacturer 201, and the like.

When a user 202 selects the car dealer 203 that is the nearest to the user's house and is the most convenient to use on the Web page of the automobile manufacturer 201, the Web page being managed by the supporting company 204, and the user decides the date of the repair or adjustment on the Web page, a reservation reception number is issued for the user 202. When this repair or adjustment is finished, the car dealer 203 transmits from the Web page to the automobile manufacturer 201 the maintenance completion report including the reservation reception number, and the user is also notified of the completion.

Thus, the supporting company 204 can know the fee that the supporting company 204 is to receive for the introduction for visit regarding the repair or the adjustment, and can surely collect the predetermined fees from the car dealers 203.

Further, the supporting company 204 is also a company that proposes the diagnosis system owned by the automobile manufacturer 201, and undertakes the development of the system. Thus, as a responsibility of the company proposing the diagnosis system, the items below are included in the initial contract for the purpose of improvement in the degree of clients' satisfaction about the diagnosis system.

(1) The supporting company 204 has the right of knowing the diagnosis-request records of the users 202 and client visit records to the car dealers 203.

(2) When the net profit that the automobile manufacturer 201 receives from the diagnosis system is surplus and the net profit of the supporting company 204 is deficiency, it is possible to review the initial contract with the automobile manufacturer 201 taking into account the profit of the respective stake holders for continuing the provision of the service that uses the diagnosis service.

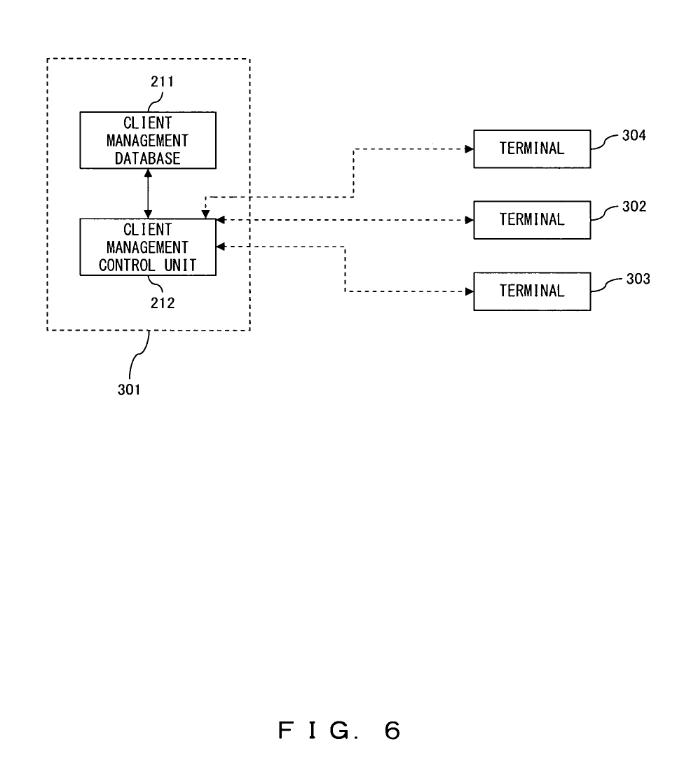

FIG. 6 shows an example of a system configuration of the diagnosis system shown in FIG. 5. In this configuration, a terminal 304 of the supporting company 204 is added to the configuration shown in FIG. 3. The client management control unit 212 in the server 301 communicates with the terminals 302 through 304 via the Internet.

The supporting company 204 is given by the automobile manufacturer 201 a right to refer to the information such as the number of contracts with the clients, the diagnosis-request records, the inspection-needing diagnosis records, and the like in order to improve the diagnosis service and to increase the income to the supporting company 204 itself. The supporting company 204 uses the dedicated ID and password to access the client management control unit 212 via the Internet in order to refer to the inspection-needing diagnosis records of the car dealers 203, and requests the permission to refer to the reservation reception number of the user 202 described in the maintenance completion report issued by the car dealer 203. Then, the supporting company 204 refers to the reservation reception number stored in the client management database 211, thereby the supporting company 204 can surely collect the introduction fee.

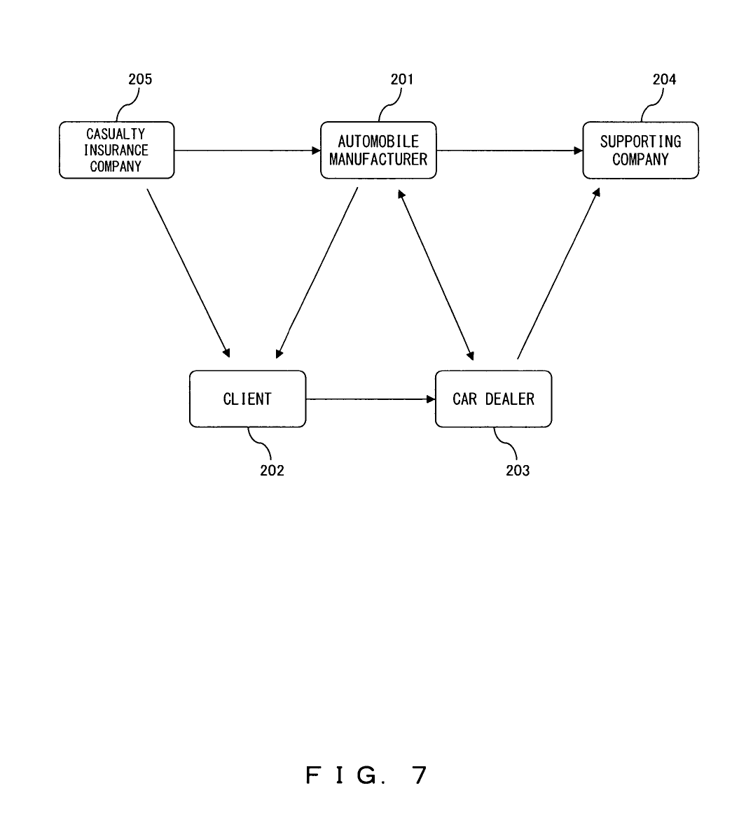

FIG. 7 shows an example of the case in which a casualty insurance company is added to the diagnosis service shown in FIG. 5. The automobile manufacturer 201 is affiliated with the casualty insurance company 205 that recognize the total merit of the diagnosis service, and the users 202 select the casualty insurance company 205 on the Web page of the automobile manufacturer 201 in order to progress the procedures of a new application for the automobile insurance. The casualty insurance company 205 notifies the automobile manufacturer 201 of the making of the new contract for insurance in accordance with the contents of the new application for insurance by the user 202, thereby the casualty insurance company 205 can obtain information about the diagnosis record of the user 202 whenever necessary.

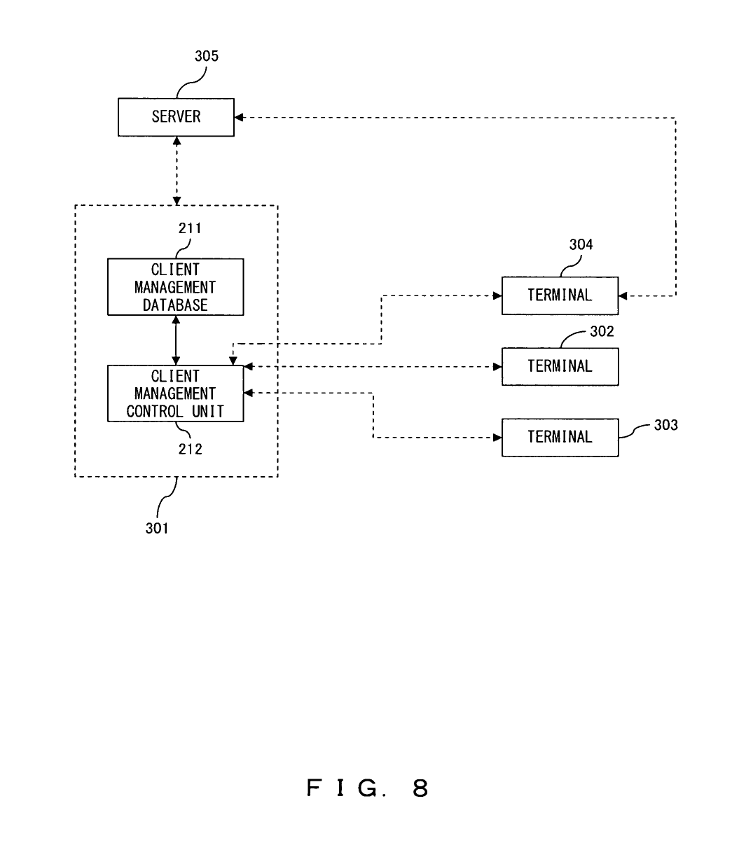

FIG. 8 shows an example of a system configuration in the diagnosis service shown in FIG. 7. In this configuration, a server 305 of the casualty insurance company 205 is added to the configuration shown in FIG. 6. The server 305 communicates with the client management control unit 212 of the server 301 and the terminals 302 of the users 202 via the Internet.

When the new contract of the insurance is made, the casualty insurance company 205 notifies the automobile manufacturer 201 of the code number of the casualty insurance company 205 and the management number of the contractor. The diagnosis system in the automobile manufacturer 201 stores, as collateral conditions of the user 202, in the client management database 211 the information of which the automobile manufacturer has been notified. The automobile manufacturer 201 assigns the casualty insurance company 205 a special code that only allows an access to the diagnosis record of the user under contract, and the casualty insurance company 205 accesses the server 301 of the automobile manufacturer 201 from the server 305. Thereby, the casualty insurance company 205 can automatically monitor the diagnosis record of the user who has made the contract for the insurance.

In the above diagnosis record stored in the client management database 211 includes the status of the diagnosis requests and safe behavior record that relate to maintenance including repairs and the like at the car dealer 203 for the user 202 based on the diagnosis result. By using this diagnosis record as a criterion, the casualty insurance company 205 can determine the amount of money that is distributed to the user 202 as the discounted portion of the insurance fee when the term of the contract is finished. Also, by having links to the system on the server 305, casualty insurance company 205 can automatically transfer the distribution to the account of the user 202 when the term of the contract is finished or when a new contract is made.

Also, in comparison with the case where the automobile manufacturer 201 encourages the users 202 who are lowly ranked in the diagnosis records, the casualty insurance company 205 can have communications with such users 202 while playing a roll of suggesting possibilities of distribution of the insurance fee, accordingly it is possible to give such users advice more sincerely. This leads to a positive growth cycle for the business system.

By employing the above configuration, the casualty insurance company 202 is affiliated with the automobile manufacturer 201, thereby it is also possible for the casualty insurance company 202 to increase the contract rate and also to reduce the total amount of insurance coverage paid. By constructing this service provision system, it is possible to allow the users 202 to request diagnosis actively to the automobile manufacturer 201, and the automobile manufacturer 201 can construct databases for storing the running statuses of automobiles more aboundingly. Also, the casualty insurance company 205 can obtain official diagnosis records from the automobile manufacturer 201 instead of obtaining the self-assessment information from the users 202, and thereby can have fair criteria for setting the insurance fee distribution, and troubles with the users under contracts can be avoided.

It is expected that the positive growth cycle caused by the above cycle should lead to the reduction of the amount of accidents due to insufficient maintenance, which is a social effect. Further, the percentage of accidents due to insufficient maintenance, a defect in the automobile or the like can be lowered, thereby when users 202 who are under contracts for the diagnosis service applies for automobile insurance, the casualty insurance company 205 can obtain the diagnosis records of the users 202 directly from the automobile manufacturer 201. Accordingly, the discounted amount of the insurance fee can be distributed to the respective users 202, such that the users 202 can use the received distribution for the annual fee for receiving the diagnosis service.

Next, the profit structure for the respective stake holders of this diagnosis service shown in FIG. 7 is explained in more detail.

The casualty insurance company 205 makes a contract with the automobile manufacturer 201 for advertisement on the Web pages on which the diagnosis service of the automobile 201 is provided, and the fee for inserting the advertisement in response to the initial fee for inserting the advertisement and/or the number of insurance contracts made is paid to the automobile manufacturer 201. The casualty insurance company 205 individually guides the users 202 under contracts for the diagnosis service to the Web page of the casualty insurance company 205 from the Web page of the automobile manufacturer 201. Also, in view of personal information protection, the casualty insurance company 205 makes contracts, on its Web page, with the users 202 that stipulates that information on the contents of the insurance contracts should not leak to the supporting company 204 or the automobile manufacturer 201.

Also, the advertisement for the casualty insurance company 205 includes the description that when users 202 makes contracts for automobile insurance, the users 202 are given the merits of cash-back or the like in the status of using the diagnosis service. When making the insurance contract, the user 202 notifies the server 305 of the contract number for the diagnosis service from the terminal 302. The casualty insurance company 205 checks the utilization status of the diagnosis service by transferring the contract number of the user 202 to the automobile manufacturer 201, thereby the casualty insurance company 205 can provide the cash-back service to the user 202 as the insurance company's service that is independent to other business parties.

Thereby, the casualty insurance company 205 can increase the number of contracts by using the diagnosis system that the automobile manufacturer 201 owns, and the automobile manufacturer 201 can get the advertisement income from the casualty insurance company 205.

The casualty insurance company 205 accesses the Web page for the diagnosis service via the Internet by using the dedicated ID and password that were assigned by the automobile manufacturer 201, thereby the casualty insurance company 205 requests permission to refer to the diagnosis-request records of the users 202 and the implementation records about inspection-needing diagnosis.

Next, casualty insurance company 205 accesses the client management database 211, and takes procedures to specify the diagnosis service contract number of which the user 202 notified the casualty insurance company 205 and the insurance contract number that specifies the user 202 who is to be referred to. Then, the casualty insurance company 205 refers to the diagnosis-request record and the implementation record of the inspection-needing diagnosis of the user 202, and writes to the database in the server 305 these information in order to automatically update the cash-back information of the user 202.

When the reference is performed by the casualty insurance company 205, the client management control unit 212 notifies the user 202 of this reference by an e-mail. Alternatively, this notification may be described on the Web page for the diagnosis service. When the casualty insurance company 205 accesses the client management database 211 without specifying the insurance contract number, the users 202 who have not made contracts for insurance are also notified of this reference, accordingly, this access are determined to be unauthorized.

The users 202 can check the cash-back information by accessing the Web page of the casualty insurance company 205 that is linked with the Web page for the diagnosis service. The automobile manufacturer 201 can check on the client management database 211 the making of the insurance contract between the casualty insurance company 205 and the user 202, and the user 202 can recognize the fact that the casualty insurance company 205 refers to the record on the diagnosis requested by the user 202, thus, the confidential between the users 202 and the casualty insurance company 205 is not undermined. However, the information provided to the casualty insurance company 205 is only the data such as the number of times of implementing diagnosises requested by the users 202, and etc.

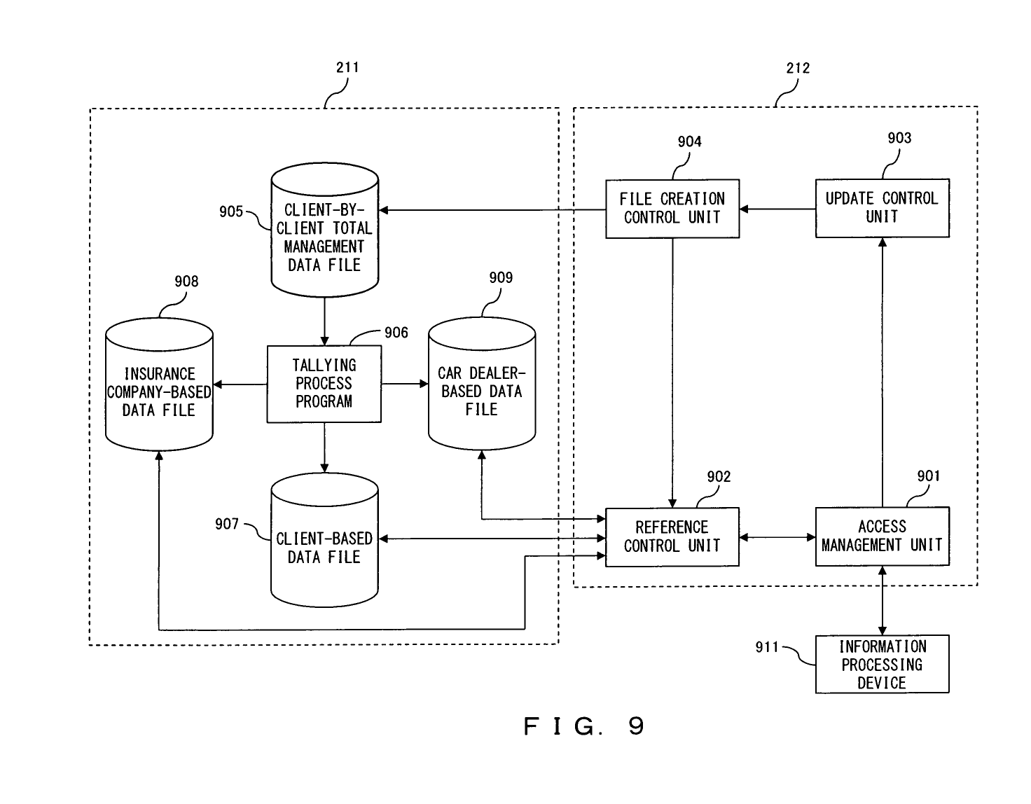

Next, the configuration and operation of the service provision system shown in FIG. 8 are explained in more detail by referring to FIGS. 9 through 15.

FIG. 9 shows a configuration example of the client management database 211 and the client management control unit 212. The client database 211 includes a client-by-client total management data file 905, a tallying process program 906, a client-based data file 907, an insurance company-based data file 908, and a car dealer-based data file 909. The client management control unit 212 includes an access management unit 901, a reference control unit 902, an update control unit 903, and a file creation control unit 904.

An information processing device 911 corresponds to any one of the terminals 302 through 304 and the server 305 shown in FIG. 8. The casualty insurance company 205 can access the client management control unit 212 by using a terminal in place of the server 305.

When a request for an access is received from the information processing device 911 of any of the users 202, the car dealers 203, and the casualty insurance company 205, the access management unit 901 determines whether or not an accessing right has been issued for this request, and determines an accessing route that is allowed in accordance with the contents to be accessed. Then, one of the reference control unit 902 and the update control unit 903 is selected as the accessing route in accordance with whether the request for an access is a request for reference or for newly updating data.

When the request for an access is only a request for reference, the reference control unit 902 performs an access control such that the access route that is not allowed is blocked and only accesses to data files the accesses to which are allowed on the basis of the IDs of the respective parties are allowed.

For example, the user 202 can access the client-based data file 907, the casualty insurance company 205 can access the insurance company-based data file 908, and the car dealer 203 can access the car dealer-based data file 909. However, none of the user 202, the car dealer 203, and the casualty insurance company 205 can access the client-by-client total management data file 905 because this file is used for the system maintenance such as modification of the systems in the automobile manufacturer 201 and the supporting company 204.

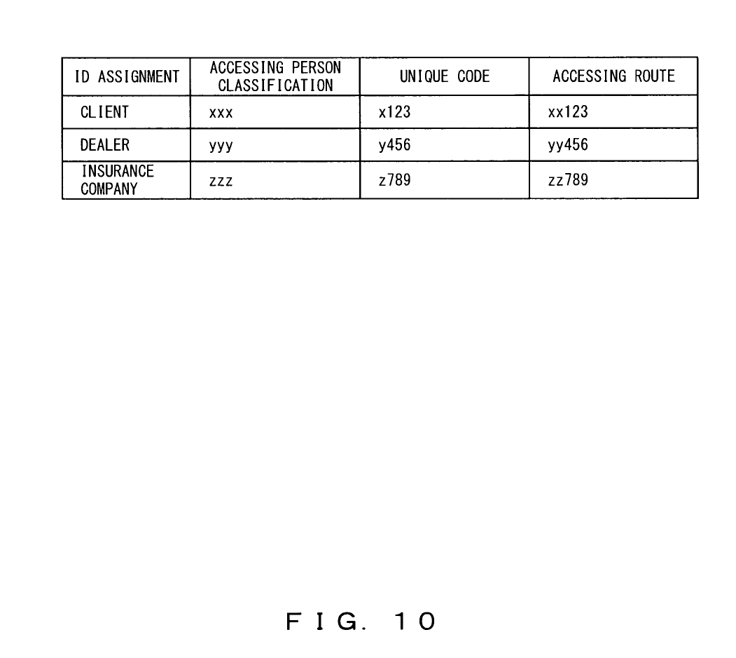

As shown in FIG. 10, an ID assigned to each of the user 202, the car dealer 203, and the casualty insurance company 205 consists of attribute information including an accessing party category, a unique code, and an accessing route. The accessing party category expresses the kind such as a client, a car dealer, a casualty insurance company, and the like, and the accessing route expresses a route to reach the access target data.

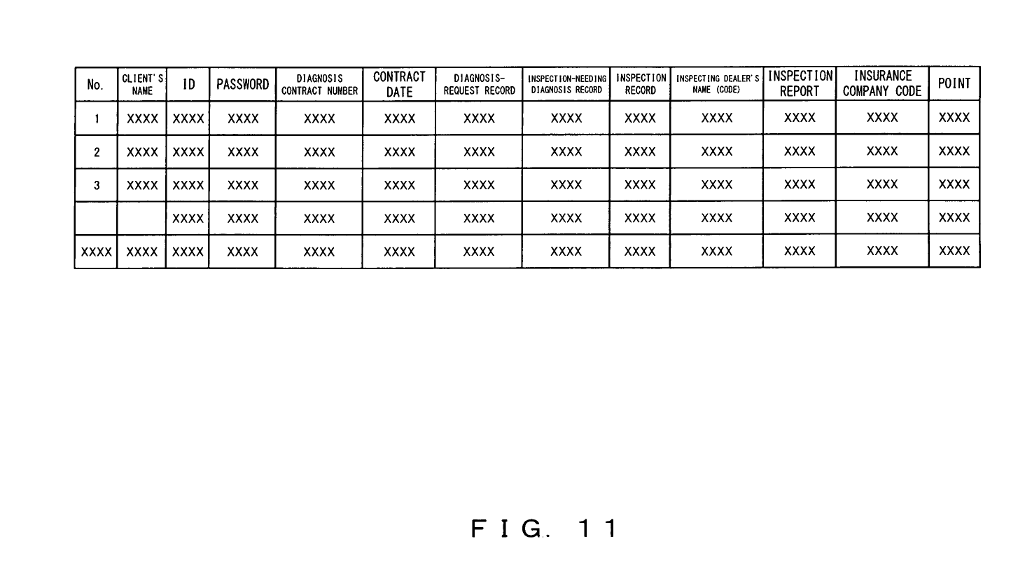

As shown in FIG. 11, the client-by-client total management data file 905 has a plurality of entries each including the items as below.

(1) Client's name

(2) ID

(3) Password

(4) Diagnosis contract number

(5) Contract date

(6) Diagnosis-request record

(7) Inspection-needing diagnosis record

(8) Inspection record

(9) Inspecting dealer's name (code)

(10) Inspection report (maintenance completion report)

(11) Insurance company code (insurance contract number, etc.)

(12) Point

In addition to the above items, it is possible to include information such as date of cancellation of a diagnosis service contract and the like. The tallying process program 906 performs the tallying process on the basis of the client-by-client total management data file 905, and creates the client-based data file 907, the insurance company-based data file 908, and the car dealer-based data file 909.

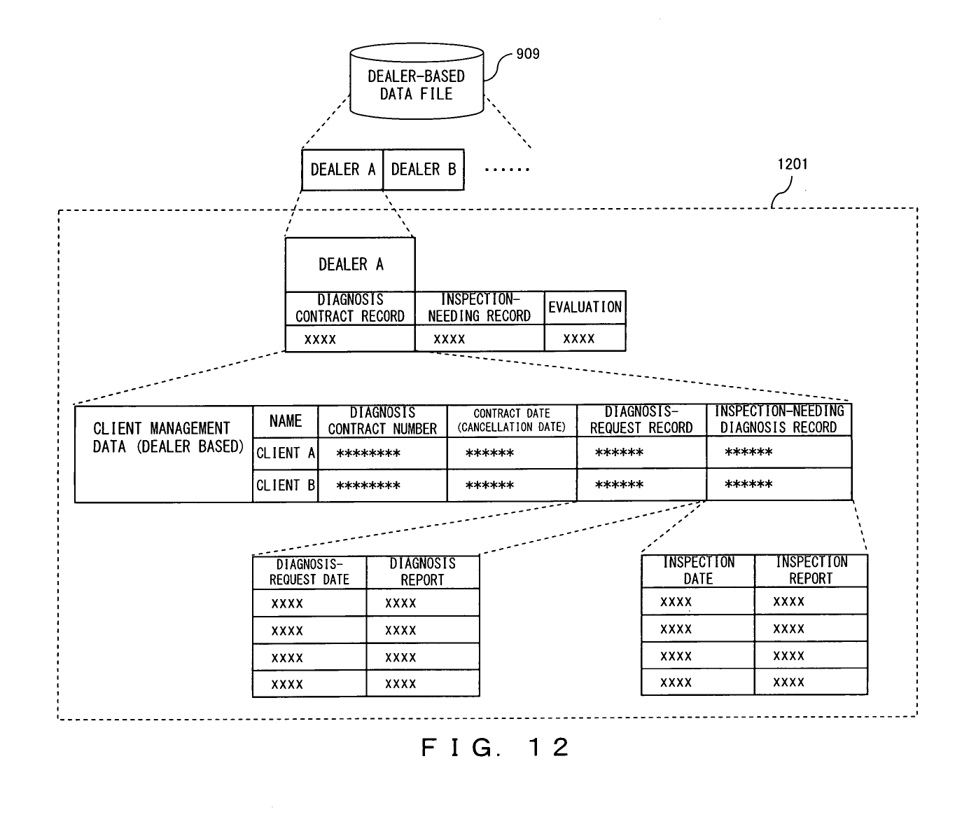

The reference control unit 902 limits the reference targets to the data that is specified by the attribute of the ID among data in the data file corresponding to the accessing party category of the ID of the accessing party. Examples of configurations of the data files and displays in the information processing device 911 are shown in FIGS. 12 through 14.

When information in lower layers are set in the respective data items shown in FIGS. 12 through 14, an accessing party can refer to the information in lower layers by specifying the data item. The data item in the uppermost layer expresses the accessing route for the accessing party, and the access can not be performed actually.

The car dealer-based data file 909 shown in FIG. 12 includes pieces of data of a plurality of car dealers, and when a car dealer “A” makes a request for reference, only the data of the car dealer “A” is displayed on a reference window 1201. In this example, the diagnosis contract record, the inspection-needing record, and the evaluation of the car dealer “A” are displayed, and the name, the diagnosis contract number, the contract date (cancellation date), the diagnosis-request record, and the inspection-needing diagnosis record of the client are displayed separately as detailed information of the diagnosis contract record. Also, as the detailed information of the diagnosis-request record, the diagnosis-request date and the diagnosis report are displayed. Further, as the detailed information of the inspection-needing diagnosis record, the inspection date and the inspection report are displayed.

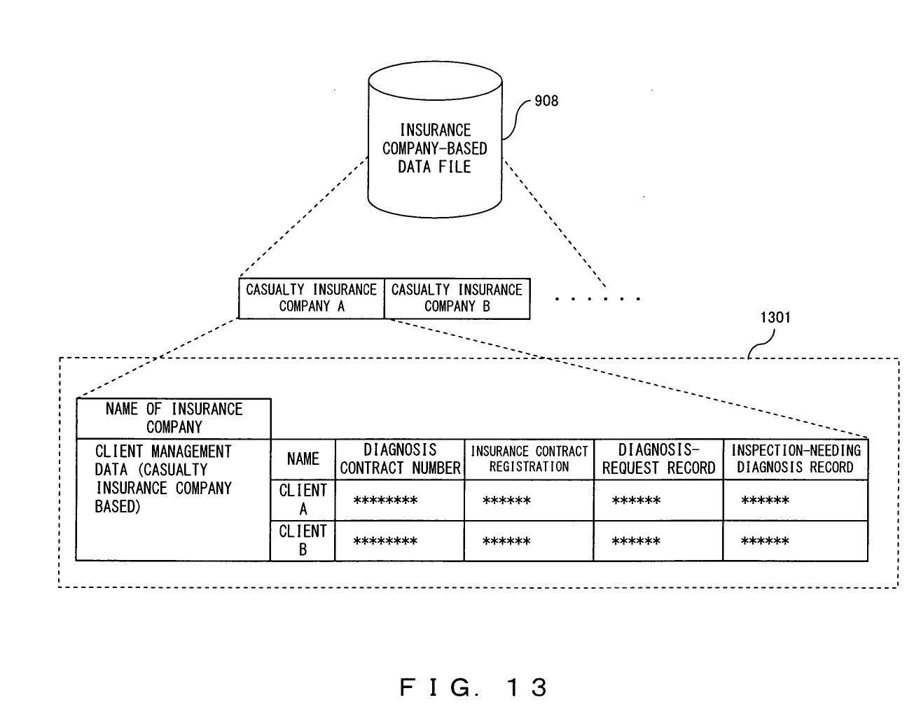

The insurance company-based data file 908 shown in FIG. 13 includes pieces of data of a plurality of casualty insurance companies. When a casualty insurance company “A” makes a request for reference, only the data of the casualty insurance company “A” is displayed on a reference window 1301. In this example, diagnosis contract numbers, the insurance contract registrations, the diagnosis-request records, and the inspection-needing diagnosis records of the clients of the casualty insurance company “A” are displayed. As information of the insurance contract registration, an insurance contract number, for example, is expressed.

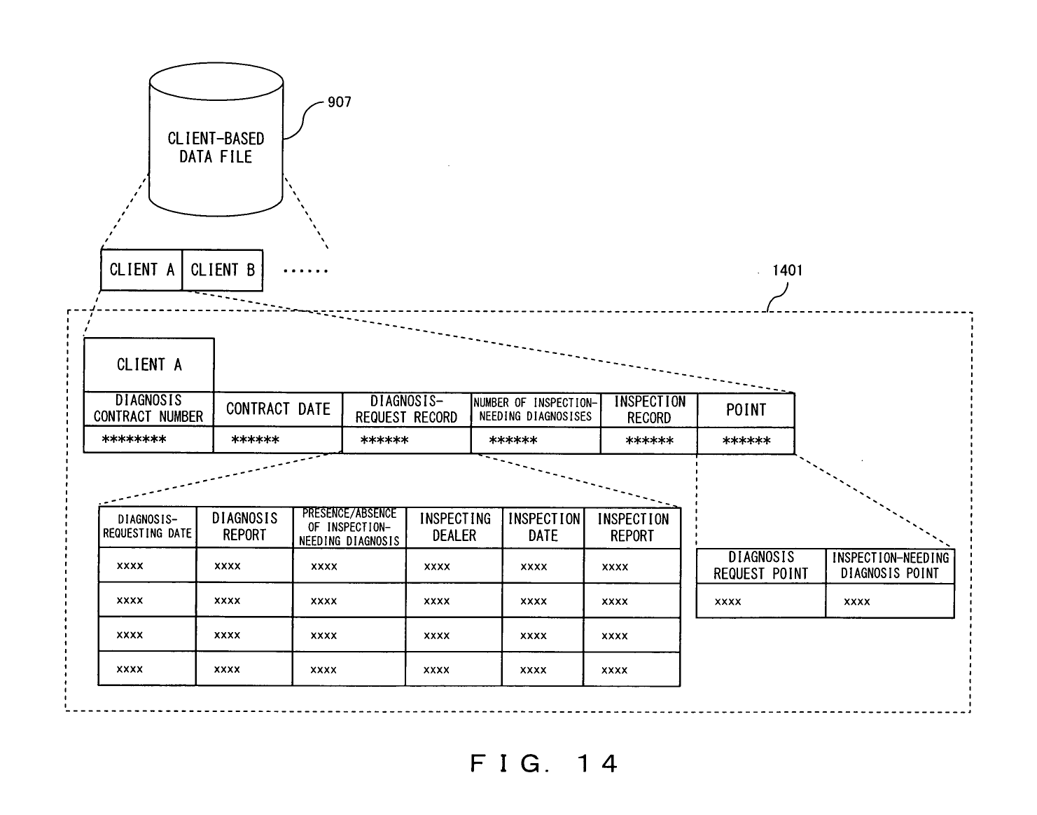

The client-based data file 907 shown in FIG. 14 includes a plurality of clients. When a client “A” makes a request for reference, only the data of the client “A” is displayed on a reference window 1401. In this example, the diagnosis contract number, the contract date, the diagnosis-request record, the number of inspection-needing diagnosises, the inspection record, and the point of the client “A” are displayed. Also, as the detailed information of the diagnosis-request records, the diagnosis request date, the diagnosis report, presence/absence of the inspection-needing diagnosis, the inspecting car dealer, the inspection date, and the inspection report are displayed. As the detailed information of the point, the diagnosis request point and the inspection-needing diagnosis point are displayed.

The car dealer-based data file 909 shown in FIG. 12, the insurance company-based data file 908 shown in FIG. 13, and the client-based data file 907 shown in FIG. 14 employ the configurations of four, two, and three layers respectively, however, data configuration is not limited to these configurations.

When there is a request for a new data update, the data update reference request is transferred from the update control unit 903 to the reference control unit 902 via the file creation control unit 904, and current data that corresponds to the accessing party is transmitted from the reference control unit 902 to the information processing device 911. When the accessing party inputs the new update data while specifying the data that is to be updated, the input data is transferred from the update control unit 903 to the file creation control unit 904. The file creation control unit 904 newly registers the entry in the client-by-client total management data file 905 or updates the entry in accordance with the data.

The tallying process program 906 updates the data files 907 through 909 on the basis of the updated client-by-client total management data file 905. The reference control unit 902 transmits the updated data in accordance with the accessing party in order to disclose the updated data.

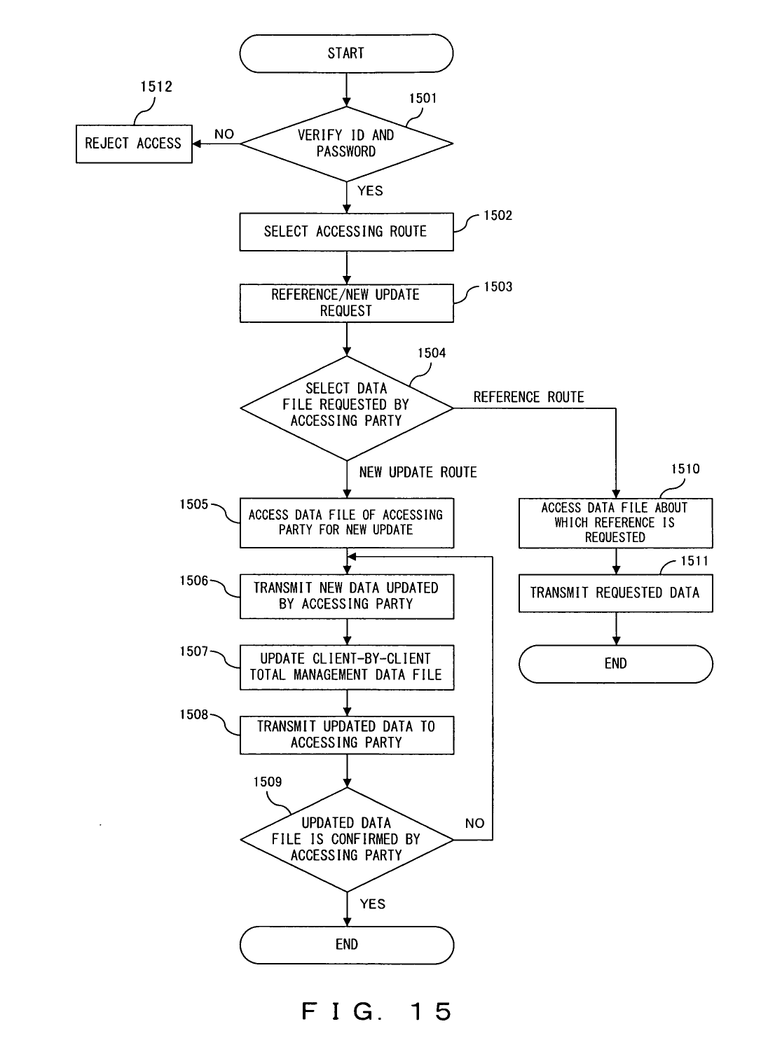

FIG. 15 is a flowchart for an accessing process in the system shown in FIG. 9. The accessing party visits the Web page of the diagnosis service by using the information processing device 911, and inputs the ID and password in order to transmit them to the client management control unit 212.

The access management unit 901 verifies the received ID and password in order to determine whether or not the access is to be permitted (step 1501). When the ID or the password is incorrect, the access is rejected (step 1512).

When the ID and password are correct, the access is permitted, the access route is selected in accordance with the attribute information of the received ID, and limitation of the access route is determined in accordance with that attribute information (step 1502). Thereby, a data file that can be accessed is specified.

Next, the data file that can be accessed is made to be open to the accessing party, and is made to be in an referable state (step 1503). The accessing party specifies the items to be referred to, and transmits to the access management unit 901 a reference request or a new update request.

The access management unit 901 receives the requests from the accessing party, determines the requested contents, and the process branches into a process for the reference request route or into a process for the new update route in accordance with the accessing party (step 1504). Thereby, the reference request and the new update request are separated into the routes that are limited for each of the clients, the casualty insurance company, and the car dealers.

Routes are managed in accordance with the IDs. For example, in the case of the user 202, a diagnosis request, a contract cancellation, and the like are new update contents. In the case of the car dealer 203, registration of the user 202 who has newly made a contract of the diagnosis service, an inspection report, and the like are new update contents. In the case of the casualty insurance company 205, contract registration of insurance for the user 202, a cancellation of an insurance contract, and the like are the new update contents.

In the case of the new update route, the reference control unit 902 accesses a data file in accordance with the accessing party prior to its update, and transmits the data to the information processing device 911 via the access management unit 901 (step 1505). Thereby, reference windows as shown in FIGS. 12 through 14 are displayed. The accessing party inputs the new update data on the displayed windows, confirms the input data, and transmits the data to the client management control unit 212 (step 1506).

Receiving this data, the file creation control unit 904 updates the client-by-client total management data file 905 (step 1507). The tallying process program 906 converts the updated client-by-client total management data file 905 into data files 907 through 909. The reference control unit 902 transmits the updated data files to the information processing device 911 via the access management unit 901 (step 1508).

The accessing party confirms the update data on the displayed windows, and checks whether or not the update contents are correct (step 1509). When the updated contents are correct, the process is terminated, and when the updated contents are incorrect, steps of and subsequent to the step 1506 are repeated for performing the update again.

In the case of the reference request route, the reference control unit 902 accesses a data file in accordance with the accessing party (step 1510), and transmits the data file to the information processing device 911 via the access control unit 901 (step 1511). Thereby, the reference windows as shown in FIGS. 12 through 14 are displayed.

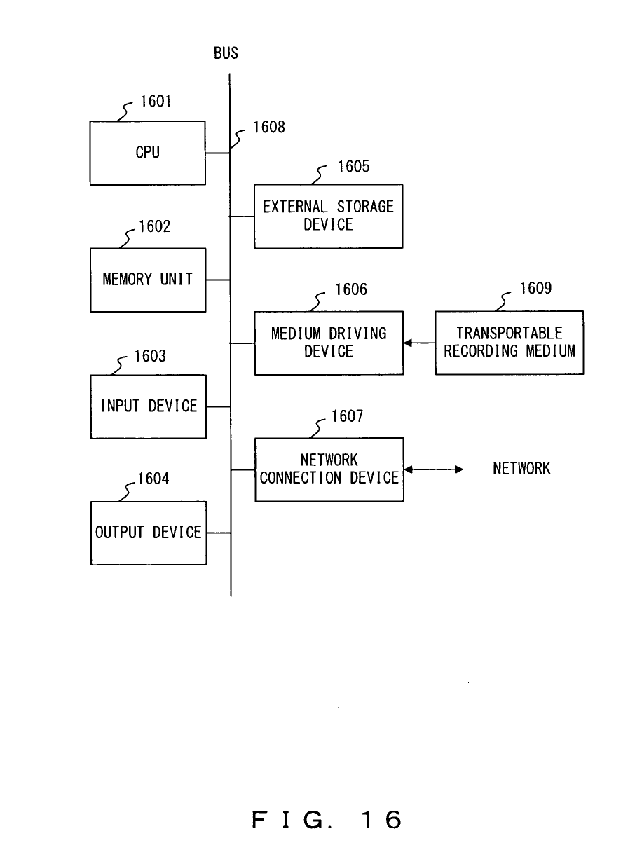

FIG. 16 shows a configuration example of an information processing device (computer) that is used as the above servers 301 and 305 and terminals 302 through 304. The information processing device shown in FIG. 16 has a CPU (Central Processing Unit) 1601, a memory unit 1602, an input device 1603, an output device 1604, an external storage device 1605, a medium driving device 1606, and a network connection device 1607 being connected with one another via a bus 1608.

The memory unit 1602 includes a ROM (read only memory) unit, a RAM (random access memory) unit, or the like in order to store program and data used for processing. The CPU 1601 performs processing as necessary by executing the programs by using the memory unit 1602.

The access management unit 901, the reference control unit 902, the update control unit 903, the file creation control unit 904, and the tallying process program 906 in FIG. 9 correspond to the program executed on the memory unit 1602.

The input device 1603 is, for example, a keyboard, a pointing device, and the like, and is used for inputting instructions and information given by the operators. The output device 1604 is, for example, a display device, a printer, a speaker system, and the like, and is used for outputting questions to the operators and process results.

The external storage device 1605 is, for example, a magnetic disk device, an optical disk device, a magneto-optical disk device, a tape device, and the like. The information processing device stores the program and data in this external storage device 1605, and uses them by loading them onto the memory unit 1602 as necessary. The external storage device 1605 can be used also as the above client management database 211.

The medium driving device 1606 drives a transportable recording medium 1609, and accesses the information recorded on the transportable recording medium 1609. The transportable recording medium 1609 is an arbitrary computer readable recording medium such as a memory card, a flexible disk, an optical disk, a magneto-optical disk, and the like. The operators store the program and data in the transportable recording medium 1609, and loads them onto the memory unit 1602 in order to use them as necessary.

The network connection device 1607 is connected to a communication network such as a LAN (local area network) or the Internet, and performs data conversion for communications. The information processing device receives the program and data from an external device via the network connection device 1607 as necessary, and loads them onto the memory unit 1602 to use them.

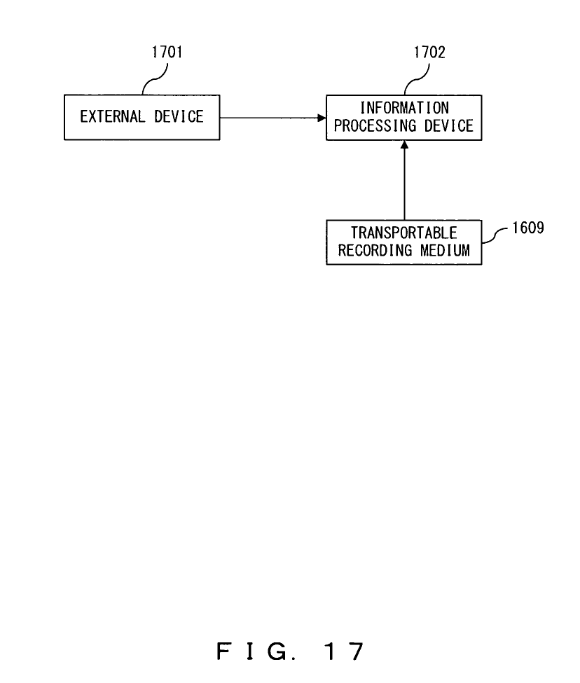

FIG. 17 shows a method of providing the program and data to the information processing device shown in FIG. 16. The program and data stored in the transportable recording medium 1609 and a database in an external device 1701 are loaded onto the memory unit 1602 in an information processing device 1702. The external device 1701 generates a carrier signal for carrying the program and data, and transmits the carrier signal to the information processing device 1702 via an arbitrary transmission medium on a communication network. The CPU 1601 uses the data in order to execute the program for performing necessary processes.

According to the present invention, when clients who received diagnosis services for mobile objects such as automobiles make requests to car dealers for inspections for repairs or adjustment, the results of the requests are managed on a database, and the clients can anytime refer to inspection reports that the car dealer prepared. Accordingly, effects of monitoring the inspection reports are attained by the clients and it is possible to deter car dealers from making deceitful reports or incorrect reports, thereby it is possible to accurately manage the operation statuses of mobile objects.

What is claimed is:

1. A client management apparatus for managing information of a plurality of clients who receive diagnosis services for mobile objects, comprising:
a client management database for storing, for each client, information of a contract number for a diagnosis service, a diagnosis-request record expressing a requesting status of the diagnosis service, an inspection-needing diagnosis record expressing a diagnosis result that requires an inspection by a car dealer for a repair or adjustment for a mobile object, an inspection record expressing an implementing status of an inspection, an inspecting car dealer that implemented the inspection, and an inspection report;
a reception unit for receiving a reference request or a data update request from a terminal of a client or a terminal of a car dealer;
an update control unit for registering, in the client management database, information of an inspection record, an inspecting car dealer, and an inspection report as information of a client whose mobile object was subjected to an inspection when receiving a data update request from a terminal of a car dealer that implemented the inspection for the mobile object;
a reference control unit for extracting information of the inspection report registered in the client management database when receiving a reference request from a terminal of the client whose mobile object was subjected to the inspection; and
a transmission unit for transmitting information of the extracted inspection report to the terminal of the client whose mobile object was subjected to the inspection.

2. A program for a computer for managing information of a plurality of clients who receive diagnosis services for mobile objects, causing the computer to execute:
creating, in a client management database, a total management data file storing, for each client, information of a contract number for a diagnosis service, a diagnosis-request record expressing a requesting status of the diagnosis service, an inspection-needing diagnosis record expressing a diagnosis result that requires an inspection by a car dealer for a repair or adjustment for a mobile object, an inspection record expressing an implementing status of an inspection, an inspecting car dealer that implemented the inspection, and an inspection report;
receiving a data update request from a terminal of a car dealer that implemented an inspection for a mobile object;
registering, in the client management database, information of an inspection record, an inspecting car dealer, and an inspection report as information of a client whose mobile object was subjected to an inspection;
receiving a reference request from a terminal of the client whose mobile object was subjected to the inspection; and
extracting information of the inspection report registered in the client management database and transmitting the extracted information to the terminal of the client whose mobile object was subjected to the inspection.

3. The program according to claim 2, wherein:
the client management database further stores information of car dealer evaluation made by a mobile object manufacturer on the basis of a contract status of the diagnosis services, diagnosis-request records, and inspection records of the plurality of clients; and
the program causes the computer to further execute a process of extracting information of corresponding car dealer evaluation from the client management database and transmitting the extracted information to a terminal of the car dealer when receiving a reference request from the terminal of the car dealer.

4. The program according to claim 3, causing the computer to execute:
creating, from the total management data file, a car dealer-based data file for storing information that a car dealer can refer to, storing the car dealer-based data file in the client management data base; and
extracting the information of the car dealer evaluation from the car dealer-based data file in order to transmit the extracted information to the terminal of the car dealer when receiving, from the terminal of the dealer, identification information specifying that an accessing party classification is a car dealer.

5. The program according to claim 2, wherein:
the client management database further stores point information that can be used for a discount provided by a mobile object manufacturer to a client on the basis of diagnosis-request records and inspection records of respective clients; and
the program causes the computer to further execute a process of extracting point information of a corresponding client from the client management database in order to transmit the extracted information to a terminal of the client when receiving a reference request from the terminal of the client.

6. The program according to claim 5, causing the computer to execute:
creating, from the total management data file, a client-based data file for storing information that a client can refer to, storing the client-based data file in the client management data base; and
extracting information of the client evaluation from the client-based data file in order to transmit the extracted information to a terminal of the client when receiving a reference request from the terminal of the client.

7. The program according to claim 2, causing the computer to further execute:
extracting information of a contract status of the diagnosis services, diagnosis-request records, and inspection-needing diagnosis records of the plurality of clients in order to transmit the extracted information to a terminal of a supporting company that supports provision of the diagnosis services when receiving a reference request from a terminal of the supporting company.

8. The program according to claim 2, wherein:
the client management database further stores information of insurance contract registration of casualty insurance for which respective clients have made contracts; and
the program causes the computer to further execute extracting information of insurance contract registration, the diagnosis-request record, and the inspection-needing diagnosis record from the client management database in order to transmit the extracted information to an information processing device of a casualty insurance company when receiving a reference request from the information processing device of the casualty insurance company.

9. The program according to claim 8, causing the computer to execute:
creating, from the total management data file, an insurance company-based data file for storing information that a casualty insurance company can refer to;
storing the insurance company-based data file in the client management data base; and
extracting the information of the insurance contract registration, the diagnosis-request record, and the inspection-needing diagnosis record from the insurance company-based data file in order to transmit the extracted information to a terminal of the casualty insurance company when receiving, from the terminal of the casualty insurance company, identification information specifying that an accessing party classification is a casualty insurance company.

10. A client management method for managing information of a plurality of clients who receive diagnosis services for mobile objects, wherein:
a file creation control unit creates, in a client management database, a total management data file storing information of a contract number for a diagnosis service, a diagnosis-request record expressing a requesting status of the diagnosis service, an inspection-needing diagnosis record expressing a diagnosis result that requires an inspection by a car dealer for a repair or adjustment for a mobile object, an inspection record expressing an implementing status of an inspection, an inspecting car dealer that implemented the inspection, and an inspection report;
a reception unit receives a data update request from a terminal of a car dealer that implemented an inspection for a mobile object;
an update control unit registers, in the client management database, information of an inspection record, an inspecting car dealer, and an inspection report as information of a client whose mobile object was subjected to an inspection;
the reception unit receives a reference request from a terminal of the client whose mobile object was subjected to the inspection;
a reference control unit extracts information of the inspection report registered in the client management database; and
a transmission unit transmits information of the extracted inspection report to the terminal of the client whose mobile object was subjected to the inspection.
